(19) United States
(12) Patent Application Publication
(10) Pub. No.: US 2018/0016194 A1
(43) Pub. Date: Jan. 18, 2018

(54) METHOD FOR PRODUCING CARBIDE DERIVED CARBON LAYER WITH DIMPLE PATTERN AND CARBIDE DERIVED CARBON LAYER WITH DIMPLE PATTERN PRODUCED BY THE METHOD

(71) Applicant: Korea University Research and Business Foundation, Seoul (KR)

(72) Inventors: Dae-Soon Lim, Seoul (KR); Eung-Seok Lee, Seoul (KR); Tae Hyun Kim, Daegu (KR); Choong Hyun Lee, Seoul (KR); Young Kyun Lim, Seoul (KR)

(73) Assignee: Korea University Research and Business Foundation, Seoul (KR)

(21) Appl. No.: 15/637,230

(22) Filed: Jun. 29, 2017

(30) Foreign Application Priority Data
Jun. 30, 2016 (KR) 10-2016-0082482

(51) Int. Cl. C04B 35/565; C04B 41/00; B23K 26/12; B23K 26/359; C04B 35/56; C04B 41/91; C04B 35/563

(52) U.S. Cl. CPC C04B 35/565; C04B 41/91; C04B 41/0036; C04B 35/563; B23K 26/359; C04B 35/5611; B23K 26/123; C04B 35/5626

(57) ABSTRACT

Disclosed is a method for producing a carbide derived carbon layer with a dimple pattern. The method includes forming a dimple pattern on the surface of a carbide ceramic material and forming a carbide derived carbon layer thereon. Also disclosed is a carbide derived carbon layer with a dimple pattern produced by the method. The carbide derived carbon layer with dimple pattern has high wear resistance, good adhesion to a machine part, and excellent frictional characteristics. The carbide derived carbon layer can be applied to various fields, such as coating of carbide coated and carbide materials. Particularly, the carbide derived carbon layer is suitable for coating of machine parts (e.g., sliding parts, mechanical seals, piston rings, and compressor vanes) where excellent mechanical properties are needed.

### CROSS-REFERENCE TO RELATED APPLICATIONS

This application claims priority to Korea Application No. 10-2016-0082482, filed Jun. 30, 2016, the disclosure of which is incorporated herein by reference.

### BACKGROUND OF THE INVENTION

### 1. Field of the Invention

The present invention relates to a method for producing a dimple-patterned carbide derived carbon layer with high wear resistance, good adhesion to a machine part, and excellent frictional characteristics by forming a dimple pattern on the surface of a carbide ceramic material and forming a carbide derived carbon layer thereon. The present invention also relates to a carbide derived carbon layer with a dimple pattern produced by the method.

### 2. Description of the Related Art

In recent years, ceramic materials have received attention as materials suitable for a variety of machine parts in various branches of industry because their advantages, such as high strength and lightweight, are well recognized. However, wear and friction caused by contact between machines shortens the lifetime of ceramic materials. This problem needs to be solved.

Carbon coating techniques have been developed to extend the lifetime of ceramic materials. Particularly, according to a carbide derived carbon (CDC) coating technique, a halogen gas is allowed to react with a carbide ceramic material at high temperature to produce a carbide derived carbon layer on the surface of the carbide ceramic material (Patent Document 1: Japanese Patent Publication No. 2010-138450). The carbide derived carbon layer exhibits excellent surface characteristics, such as low friction and good wear resistance, but the formation of pores by extraction of the metal atoms from the carbide ceramic material deteriorates the frictional characteristics and strength of the carbide derived carbon layer, causing problems in terms of durability and reliability.

Diamond like carbon (DLC) has the advantages of high hardness, excellent frictional characteristics, and low-temperature processability but is likely to be peeled off from machine parts due to its low adhesion and bonding strength to the machine parts. Other disadvantages of diamond like carbon are its very low growth, complex production process, and high production cost.

In an attempt to solve such problems, a technique is known in which carbon nanotubes and a carbide compound are allowed to react with a halogen-containing gas to produce a hybrid composite (Patent Document 2: Japanese Patent Publication No. 2008-542184). However, the hybrid composite exhibits poor mechanical surface characteristics and has higher roughness and lower hardness than diamond like carbon (DLC) due to the formation of pores by extraction of the metal atoms.

In view of this, efforts have been made to overcome the disadvantages of diamond like carbon (DLC), such as poor adhesion to metal machine parts and long processing time. For example, a technique is known in which diamond like carbon (DLC) is formed by nitriding the surface of a metal machine part with hydrogen plasma and nitrogen plasma and subjecting the pretreated metal machine part to plasma enhanced chemical vapor deposition (PECVD) (Patent Document 3: Korean Patent Publication No. 2008-0099624). However, the diamond like carbon is still unsatisfactory in adhesive strength and lifetime. The production procedure is complex and the surface of the machine part should be flat because the vapor deposition is limited to flat coating, causing many difficulties in process control.

### SUMMARY OF THE INVENTION

The present invention has been made in an effort to solve the above problems, and it is one object of the present invention to provide a method for producing a dimple-patterned carbide derived carbon layer by forming a dimple pattern on the surface of a carbide ceramic material so that the coating thickness of the carbide derived carbon layer can be made uniform without depending on the surface state of the carbide ceramic material and the surface roughness of the carbide derived carbon layer can be reduced irrespective of the coating thickness, achieving high wear resistance, good adhesion to the carbide ceramic material, and excellent frictional characteristics. It is a further object of the present invention to provide a carbide derived carbon layer with a dimple pattern produced by the method.

One aspect of the present invention provides a method for producing a carbide derived carbon layer with a dimple pattern, including (a) irradiating a laser onto the surface of a carbide ceramic material to form a dimple pattern, (b) feeding a halogen gas to the dimple-patterned carbide ceramic material and allowing the halogen gas to react with the carbide ceramic material to form a carbide derived carbon layer, and (c) feeding hydrogen gas to the carbide derived carbon layer to remove residual chlorine compounds.

According to one embodiment of the present invention, the dimple pattern may consist of dimples spaced apart from one another and arranged in the form of a lattice.

According to a further embodiment of the present invention, the diameter of the dimples may be from 50 to 200 μm and the distance between the centers of the adjacent dimples may be from 2 to 5 times the diameter of the dimples.

According to another embodiment of the present invention, the depth of the dimples may be from 20 to 60 μm.

According to another embodiment of the present invention, the carbide ceramic material may be represented by MexCy wherein x and y are each independently an integer from 1 to 6 and Me is selected from the group consisting of Si, Ti, W, Fe, B, and alloys thereof.

According to another embodiment of the present invention, the halogen gas may be selected from the group consisting of chlorine gas, fluorine gas, bromine gas, and iodine gas.

According to another embodiment of the present invention, step (b) may be carried out at a temperature of 500 to 1500° C. for 0.5 to 10 hours.

The present invention also provides a carbide derived carbon layer with a dimple pattern produced by the method.

According to one embodiment of the present invention, the carbide derived carbon layer may have a thickness of 20 to 40 μm.

According to a further embodiment of the present invention, the carbide derived carbon layer may have a friction coefficient of 0.05 to 0.2.

According to the present invention, the formation of the dimple pattern on the surface of the carbide ceramic material contributes to a reduction in contact area with a mechanical element and facilitates the collection of wear particles removed from the contact area in the dimple structures, leading to markedly improved wear resistance and frictional characteristics of the carbide derived carbon layer.

Therefore, the dimple-patterned carbide derived carbon layer of the present invention can be applied to various fields carbide coated and carbide materials. Particularly, the dimple-patterned carbide derived carbon layer of the present invention is suitable for coating of machine parts (e.g., sliding parts, mechanical seals, piston rings, and compressor vanes) where excellent mechanical properties are needed.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a schematic diagram showing an arrangement of dimples in a dimple pattern formed in accordance with a method of the present invention;

FIG. 2 shows a side SEM image of a carbide derived carbon layer with a dimple pattern produced by a method of the present invention;

FIGS. 3A, 3B, 3C and 3D show surface SEM images of dimple-patterned carbide derived carbon layers produced in Examples 1 to 4, respectively;

FIG. 4 shows a side SEM image of a carbide derived carbon layer with a dimple pattern produced by a method of the present invention;

FIG. 5 is a histogram showing the friction coefficients of dimple-patterned carbide derived carbon layers produced in Examples 1 to 4 and Comparative Example 1; and

FIG. 6 is a graphical illustration showing the wear rates of dimple-patterned carbide derived carbon layers produced in Examples 1 to 4 and Comparative Example 1.

### DETAILED DESCRIPTION OF THE INVENTION

The present invention will now be described in more detail.

Conventional carbon film coating techniques suffer from poor adhesion of carbon films to machine parts, complex production processes, and difficulty in obtaining uniform thicknesses depending on the surface state of carbide ceramics upon coating.

Thus, the present invention is intended to provide a method for producing a dimple-patterned carbide derived carbon layer by forming a dimple pattern on the surface of a carbide ceramic material so that the coating thickness of the carbide derived carbon layer can be made uniform without depending on the surface state of the carbide ceramic material and the surface roughness of the carbide derived carbon layer can be reduced irrespective of the coating thickness, achieving high wear resistance, good adhesion to the carbide ceramic material, and excellent frictional characteristics. The present invention is also intended to provide a carbide derived carbon layer with a dimple pattern produced by the method.

Specifically, the present invention provides a method for producing a carbide derived carbon layer with a dimple pattern, including (a) irradiating a laser onto the surface of a carbide ceramic material to form a dimple pattern, (b) feeding a halogen gas to the dimple-patterned carbide ceramic material and allowing the halogen gas to react with the carbide ceramic material to form a carbide derived carbon layer, and (c) feeding hydrogen gas to the carbide derived carbon layer to remove residual chlorine compounds.

According to the method of the present invention, the formation of the dimple pattern on the surface of the carbide ceramic material in step (a) contributes to a reduction in contact area with a mechanical element and facilitates the collection of wear particles removed from the contact area in the dimple structures, leading to markedly improved wear resistance and frictional characteristics of the carbide derived carbon layer.

The dimple pattern may consist of dimples spaced apart from one another on the surface of the carbide ceramic material and arranged in the form of a lattice, as shown in FIG. 3.

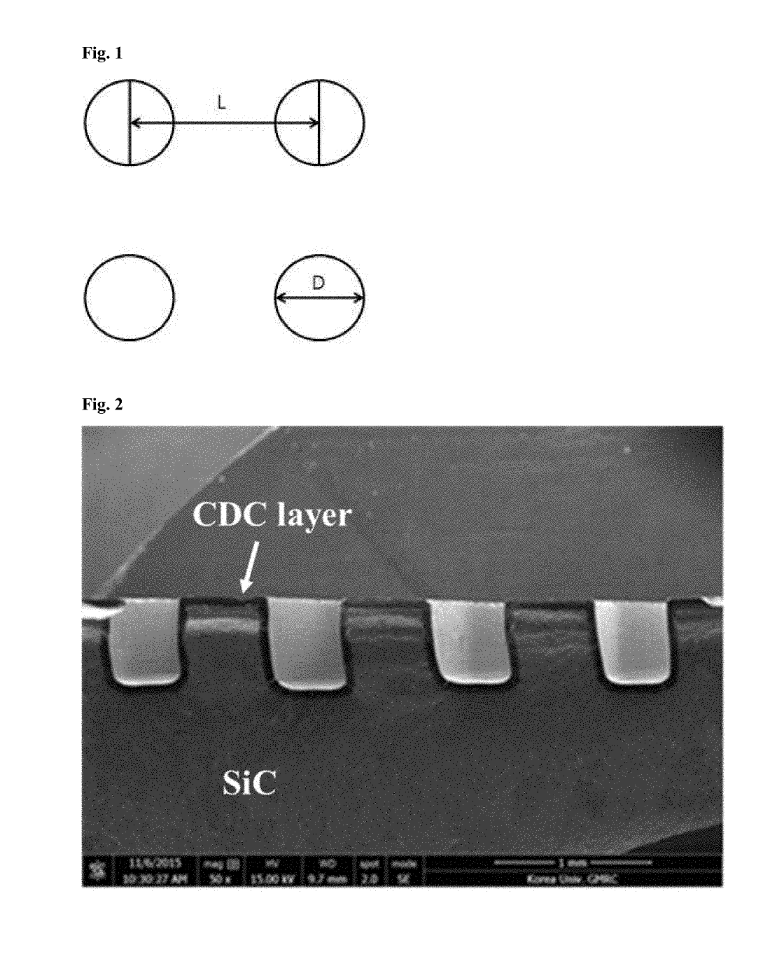

Here, the dimple pattern is formed by irradiation with a laser having a pulse width as large as possible for surface texturing. The dimples are hemispherical recesses and are arranged at regular intervals in the form of a lattice. The entrances of the dimples have a diameter (D) in the range of 50 to 200 μm. It is preferred that the distance (L) between the centers of the adjacent dimples is from 2 to 5 times the diameter of the dimples, which is evident from the results in the Examples section that follows (FIGS. 1 and 3).

Preferably, the depth of the dimples is from 20 to 60 μm.

Next, in step (b), a halogen gas is fed to the carbide ceramic material whose surface is dimple patterned and is allowed to react with the carbide ceramic material to form a carbide derived carbon layer on the surface of the carbide ceramic material.

For example, chlorine gas as the halogen gas is fed to and reacts with SiC as the carbide ceramic material whose surface is dimple patterned at high temperature. The reaction proceeds according to the following scheme 1:

SiC(s)+2Cl2(g)→SiCl4(g)+C(s) (1)

As depicted in Scheme 1, SiCl4 is preferentially formed rather than CCl4 because the former is more thermodynamically than the latter.

More specifically, the gaseous SiCl4 is removed and a carbide derived carbon (CDC) layer is formed on the surface of the carbide ceramic material. The Cl2 gas is diffused into the carbide derived carbon layer to extract the Si atoms present in the carbide derived carbon layer. This continuous process increases the reaction time, leading to an increase in the thickness of the carbide derived carbon layer.

The carbide ceramic material may be represented by MexCy wherein x and y are each independently an integer from 1 to 6 and Me is selected from the group consisting of Si, Ti, W, Fe, B, and alloys thereof. The carbide ceramic material may be, for example, selected from the group consisting of SiC, TiC, WC, FeC, BC, and alloys thereof.

The carbide ceramic material is intended to include its single-crystal form, polycrystalline form, sintered body, and mixed sintered body.

The halogen gas is not particularly limited and may be a gaseous element belonging to the halogen group of the periodic table. Preferably, the halogen gas is selected from the group consisting of chlorine gas, fluorine gas, bromine gas, iodine gas, and mixtures thereof.

One or more gases selected from the group consisting of argon, nitrogen, and helium gases may be added to adjust the concentration of the halogen gas in step (b) of forming the carbide derived carbon layer.

The concentration of the halogen gas is preferably adjusted to 0.1 to 10% by volume. If the halogen gas is present at a concentration of 0.1% by volume or less, the reaction time may be excessively long. Meanwhile, if the halogen gas is present at a concentration exceeding 10% by volume, the carbon atoms remaining after extraction of the metal atoms do not readily recombine with each other, resulting in a greatly increased number of pores.

Hydrogen gas may also be added to improve the crystallinity of the carbide derived carbon layer.

In step (b), the reaction temperature is preferably from 500 to 1,500° C. A temperature lower than 500° C. may be insufficient for the reaction to take place. Meanwhile, an excessively high temperature exceeding 1,500° C. may cause a physical or chemical change of the carbide derived carbon layer. The temperature may vary depending on the kind of the carbide ceramic material used.

As an example, the carbide ceramic material may be SiC. In this case, it is preferred that the reaction temperature is from 850 to 1500° C. Alternatively, in the case where the carbide ceramic is TiC, the reaction temperature is preferably from 350 to 1200° C. This explains the dependency of the reaction temperature on the kind of the carbide ceramic material.

As described above, the feeding of the halogen gas enables the formation of the carbide derived carbon layer that can be prevented from being peeled off while achieving a desired thickness.

In step (b), the reaction with the halogen gas is preferably carried out for 0.5 to 10 hours. If the reaction time is shorter than 0.5 hours, the carbide derived carbon (CDC) layer may not be formed to a sufficient thickness. Meanwhile, if the reaction time exceeds 10 hours, the carbide ceramic material may be excessively crystallized, and at the same time, a reduced number of pores may be formed. Excessive crystallization of the carbide ceramic material may change the basic physical and chemical properties of the carbide derived carbon layer. The formation of a reduced number of pores may make it difficult for the reactant gas to penetrate into the carbide derived carbon layer and may lead to slow formation of the coating layer. The excessive time consumption is inefficient in terms of production cost.

The carbide derived carbon (CDC) layer may include one or more carbon crystal structures selected from the group consisting of 1 to 100 nm-sized graphite, carbon nanotubes (CNTs), and onion-like carbon (OLC).

A conventional carbide derived carbon layer containing a carbon crystal is susceptible to additional wear caused by wear particles formed when a mechanical element is rubbed on the surface of the carbide derived carbon layer, thus losing its friction coefficient. In contrast, according to the method of the present invention, the formation of the dimple pattern on the surface of the carbide ceramic material in step (a) before the formation of the carbide derived carbon layer contributes to a reduction in contact area (contact resistance) with a mechanical element and facilitates the collection of wear particles removed from the contact area in the dimple structures, bringing about a marked improvement in the wear resistance and frictional characteristics of the carbide derived carbon layer.

The present invention also provides a carbide derived carbon layer with a dimple pattern produced by the method.

The carbide derived carbon layer may have a thickness of 20 to 40 μm and a friction coefficient of 0.05 to 0.2.

The present invention will be explained in more detail with reference to the following examples. However, it will be obvious to those skilled in the art that these examples are provided for illustrative purposes only and are not intended to limit the scope of the invention.

### Examples 1-4

Hot sintered polycrystalline SiC substrates were used as starting carbide ceramics. A laser was irradiated onto each of the polycrystalline SiC substrates to form a dimple pattern on the substrate surface. In the dimple pattern, the diameter of the dimples was set to 100 μm and the distance between the centers of the dimples was set to 250 μm (Example 1), 400 μm (Example 2), 600 μm (Example 3), and 1100 μm (Example 4).

The dimple-patterned polycrystalline SiC substrate was placed in a vertical electric furnace, which was then heated to 1000° C.

Immediately after the furnace temperature reached 1000° C., 5 vol % of chlorine gas as a halogen gas was introduced into the electric furnace and was allowed to react with the hot sintered polycrystalline SiC substrate for 4 h.

After the introduction of the chlorine gas was stopped, argon and hydrogen gases were fed. The reaction was continued at a temperature of 800° C. for additional 2 h to remove residual chlorine compounds, and as a result, a specimen coated with a carbide derived carbon (CDC) layer with a dimple pattern was obtained.

### Comparative Example 1

A carbide derived carbon (CDC) layer was produced in the same manner as in Examples 1-4, except that a dimple pattern was not formed on the surface of the carbide ceramic material.

FIG. 3 shows surface SEM images of the dimple-patterned carbide derived carbon layers produced in Example 1 (a), Example 2 (b), Example 3 (c), and Example 4 (d). The SEM images reveal that each of the dimple patterns was uniformly formed in the form of a regular lattice on the surface of the carbide derived carbon layer. The density of the dimples on the surface of the carbide derived carbon layer decreased with increasing distance between the dimples.

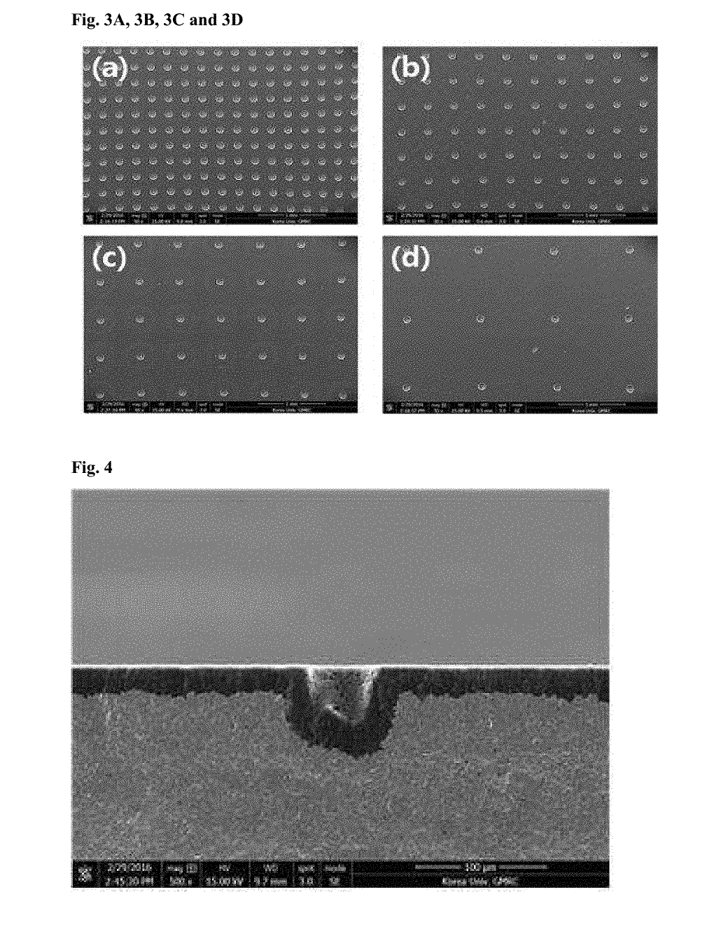

FIG. 4 shows a side SEM image of the carbide derived carbon layer with a dimple pattern. The SEM image confirms that the thickness of the carbide derived carbon layer was uniform without depending on the surface state of the carbide ceramic material.

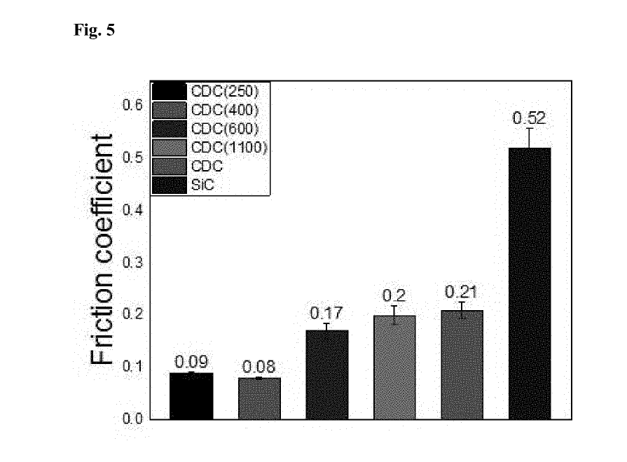

FIG. 5 is a histogram showing the friction coefficients of the dimple-patterned carbide derived carbon layers produced in Examples 1-4 and Comparative Example 1. The results in FIG. 5 demonstrate that the friction coefficients of the dimple-patterned carbide derived carbon layers produced in Examples 1-4 were much lower than that of the carbide derived carbon layer produced in Comparative Example 1. Particularly, the densities of the dimples in the dimple-patterned carbide derived carbon layers produced in Examples 1-2 were higher due to the decreased distances between the centers of the dimples, which explains their lowest friction coefficients.

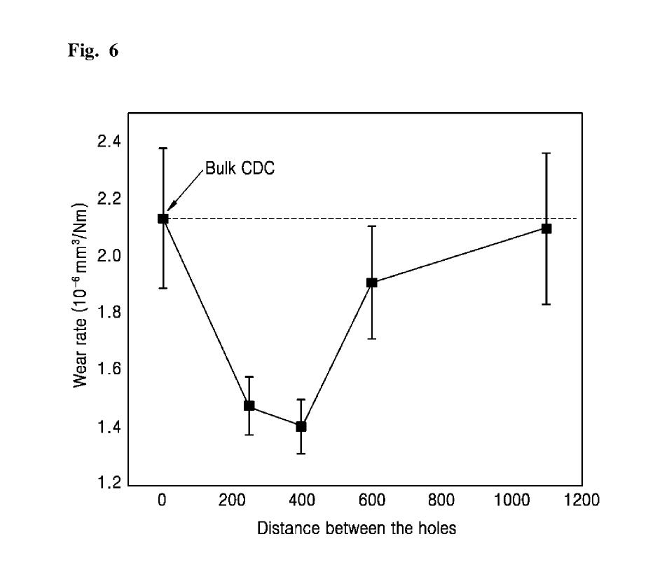

FIG. 6 is a graphical illustration showing the wear rates of the dimple-patterned carbide derived carbon layers produced in Examples 1 to 4 and Comparative Example 1. The graph of FIG. 6 demonstrates that the wear rates of the dimple-patterned carbide derived carbon layers produced in Examples 1-4 were much lower than that of the carbide derived carbon layers produced in Comparative Example 1. Particularly, the densities of the dimples in the dimple-patterned carbide derived carbon layers produced in Examples 1-2 were higher due to the decreased distances between the centers of the dimples, which explains their lowest wear rates.

As can be seen from the above results, the friction coefficient and wear rate of each of the dimple-patterned carbide derived carbon layers produced in Examples 1-4 vary depending on the density of the dimples in the pattern, which is inversely proportional to the distance between the centers of the dimples on the surface of the carbide derived carbon layer. That is, the friction coefficient and wear rate of the dimple-patterned carbide derived carbon layer are highly correlated with the density of the dimples in the pattern, which is inversely proportional to the distance between the centers of the dimples. This correlation is difficult to ascertain when the density of the dimples is very low. Therefore, it can be concluded that it is preferable to control the density of the dimples by varying the distance between the dimples depending on the desired friction coefficient and wear rate of the carbide derived carbon layer.

What is claimed is:

1. A method for producing a carbide derived carbon layer with a dimple pattern, comprising (a) irradiating a laser onto the surface of a carbide ceramic material to form a dimple pattern, (b) feeding a halogen gas to the dimple-patterned carbide ceramic material and allowing the halogen gas to react with the carbide ceramic material to form a carbide derived carbon layer, and (c) feeding hydrogen gas to the carbide derived carbon layer to remove residual chlorine compounds.

2. The method according to claim 1, wherein the dimple pattern consists of dimples spaced apart from one another and arranged in the form of a lattice.

3. The method according to claim 1, wherein the diameter of the dimples is from 50 to 200 μm and the distance between the centers of the adjacent dimples is from 2 to 5 times the diameter of the dimples.

4. The method according to claim 1, wherein the depth of the dimples is from 20 to 60 μm.

5. The method according to claim 1, wherein the carbide ceramic material is represented by MexCy wherein x and y are each independently an integer from 1 to 6 and Me is selected from the group consisting of Si, Ti, W, Fe, B, and alloys thereof.

6. The method according to claim 1, wherein the halogen gas is selected from the group consisting of chlorine gas, fluorine gas, bromine gas, and iodine gas.

7. The method according to claim 1, wherein step (b) is carried out at a temperature of 500 to 1500° C. for 0.5 to 10 hours.

8. A carbide derived carbon layer with a dimple pattern produced by the method according to claim 1.

9. The carbide derived carbon layer according to claim 8, wherein the carbide derived carbon layer has a thickness of 20 to 40 μm.

10. The carbide derived carbon layer according to claim 8, wherein the carbide derived carbon layer has a friction coefficient of 0.05 to 0.2.
